(19) United States
(12) Patent Application Publication
(10) Pub. No.: US 2005/0063499 A1
(43) Pub. Date: Mar. 24, 2005

(54) Method for the continuous estimation of the equalizer coefficients for wire-bound transmission systems

(76) Inventors: Thomas Ahrndt, Ottobrunn (DE); Robert Klinski, Munchen (DE)

Correspondence Address: Siemens Corporation;Intellectual Property Department, 170 Wood Avenue South, Iselin, NJ, 08830, US

(21) Appl. No.: 10/498,080

(22) PCT Filed: Dec. 9, 2002
(86) PCT No.: PCT/DE02/04518

(30) Foreign Application Priority Data
Dec. 11, 2001 (DE) 101 60 733.4

(51) Int. Cl. H04B 1/10

(52) U.S. Cl. 375/350

(57) ABSTRACT

The invention relates to a data reception method, a data communication system, and to a receiver or transmitter/receiver device that is adapted to receive modulated transmission signals from a transmitter or an additional transmitter/receiver device via a transmission channel. Synchronization data is transmitted by means of the transmission signals which are used to synchronize the receiver device. The receiver or transmitter/receiver device is provided with an equalizer which equalizes the received or derived signals. The inventive method is further characterized in that the same transmission signals with which the synchronization data is transmitted are used to adjust the equalizer.

The invention relates to a receiver or transmitter/receiver device according to the preamble of claim 1, a data communication system with such a receiver device, as well as a data reception method according to the preamble of claim 15. Data communication systems generally feature one or more transmitters or transmitter/receiver devices from which transmission signals are transmitted for example via twisted-pair lines to one or more receivers or transmitter/receiver devices and vice versa.

For example, the transmitter device can be an electronic module provided in an EWSD terminal exchange (EWSD=digital electronic switching system) that has a number of modems. A subscriber connecting line, for example a twisted-pair line, is connected to each modem via which the transmission signals modulated in each case are transmitted for example to a modem provided at a subscriber terminal. Corresponding transmission signals are also transmitted to the subscriber terminal modem (e.g. via an additional twisted-pair line) and received by the corresponding terminal exchange modem.

Data can be communicated for example between the modems (modulators—demodulators) on the basis of POTS (plain old telephone service), ISDN (integrated services digital network) or xDSL (x digital subscriber line) data transmission protocols, for example, by means of ADSL data transmission or according to the standards ITU G.992.1 (G.dmt) or ITU G.992.2 (G.Lite).

In the case of data communication according to an XDSL protocol, several frequency bands (bins) are used that lie above the frequency bands used for the POTS or ISDN data transmission.

A QAM data transmission method can for example be used to transmit data via the XDSL frequency bands. In this case, a cosine oscillation can be used in a specific frequency band in each case whose frequency is e.g. in the middle of the corresponding frequency band.

A cosine oscillation with a specific amplitude and phase is allocated to each bit to be transmitted or each bit sequence to be transmitted (e.g. by using a phase star). From the amplitude and phase of the cosine oscillation received in each case, the bit transmitted in each case or the bit sequence transmitted in each case can then be determined in the receiver device.

For example, in the case of the DSL data transmission method, both the actual useful data and the synchronization data are transmitted.

Synchronization data is transmitted during a predetermined time interval defined in the DSL standard (i.e. during the so-called synchronization data frame or frames). The actual useful data is transmitted in the following time interval on the synchronization frame that is sub-divided into 68 subsections (useful data frames).

The synchronization data frames and the subsequent 68 useful data frames together form a DSL super or metaframe consisting of a total of 69 frames.

A synchronization data bit sequence identical to the synchronization data bit sequence transmitted by the specific transmitter/receiver device is initially stored in the (additional) transmitter/receiver device communicating with the specific transmitter/receiver device.

Here, the data bit sequence received in each case is compared with the initially stored synchronization data bit sequence. Depending on whether or not an agreement can be reached, the bit sequence received in each case must be allocated to a synchronization data frame or a useful data frame. As a result, a temporary coordination of the DSL data transmission between the transmitting and the receiving transmitter/receiver device can be obtained in each case.

In the case of DSL data transmission via a specific twisted-pair line, the originally transmitted signal can be distorted for many reasons.

In order to compensate for the distortions, an (adjustable) equalizer is provided on the specific receiver device in which the received signal is equalized.

The above-mentioned DSL standards (ITU G.992.1 (G.dmt) or ITU G.992.2 (G.Lite)) provide that during an initializing phase of the corresponding transmitter/receiver devices (i.e. before actual data transmission), the distortion characteristics of the specific transmission channel be determined.

For this, so-called training sequences are transmitted from the specific transmitter device during the initializing phase. These are well-known in the specific transmitter device and are compared there with the actually received (interrupted) training sequences. From this, the (momentary) channel distortions can be determined in a known way.

Accordingly, the above-mentioned equalizer can then be set in such a way that the received signals are equalized (as good as possible).

Because the distortion characteristics of the specific transmission channel change continuously, the equalizer is adjusted at regular intervals.

However, after the above-mentioned initializing phase has ended, i.e. after the actual (useful) data transmission has started, training sequences are no longer transmitted according to the above mentioned DSL standards.

Therefore, during the actual transmission of useful data, statistical methods are used to determine the (possibly changed) distortion characteristics of the transmission channel, e.g. statistical gradient algorithms, for example, an LMS algorithm.

The object of the invention is to make available an innovative receiver or transmitter/receiver device, a new data communication system with such a receiver or transmitter/receiver device as well as an innovative data reception method.

The object of the invention and additional objectives is achieved by means of claims 1, 13 and 15. Advantageous additional developments of the invention are given in the subclaims.

According to a basic idea of the invention, a receiver device or a transmitter/receiver device is provided that is adapted to receive modulated transmission signals from a transmitter or an additional transmitter/receiver device via a transmission channel in which case synchronization data is transmitted by means of the transmission signals which are used to synchronize the receiver device and in which case the receiver or transmitter/receiver device is provided with an equalizer which equalizes the received or derived signals, characterized in that the same transmission signals by means of which the synchronization data is transmitted are used to adjust the equalizer.

As a result, the equalizer can particularly be adjusted relatively quickly and with a relatively high accuracy even if the initializing phase of the receiver device has already ended (i.e. during the actual transmission of useful data). The good equalizing of received or derived signals brings about a bit error rate that is lower than the prior art.

Advantageously, the synchronization data includes a synchronization data bit sequence which is compared with a synchronization of the receiver or transmitter/receiver device with a bit sequence initially stored in a storage device of the receiver or transmitter/receiver device.

For a preferred embodiment, the transmission signals which are used to synchronize the receiver or transmitter/receiver device and to adjust the equalizer are transmitted during a synchronization frame and the actual useful data during a (useful) data frame.

The invention is explained in greater detail below on the basis of several embodiments and the accompanying drawings. They are as follows:

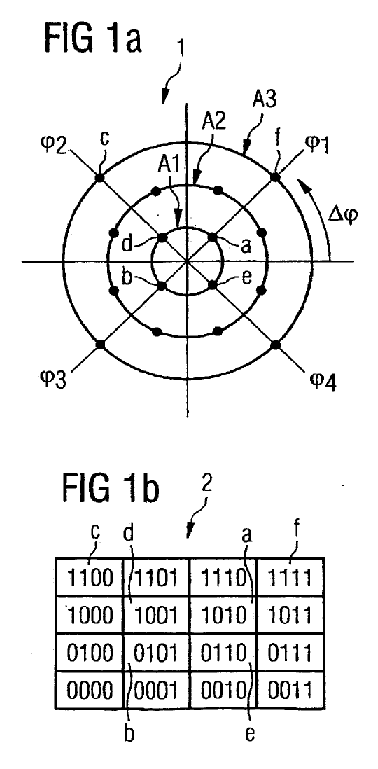

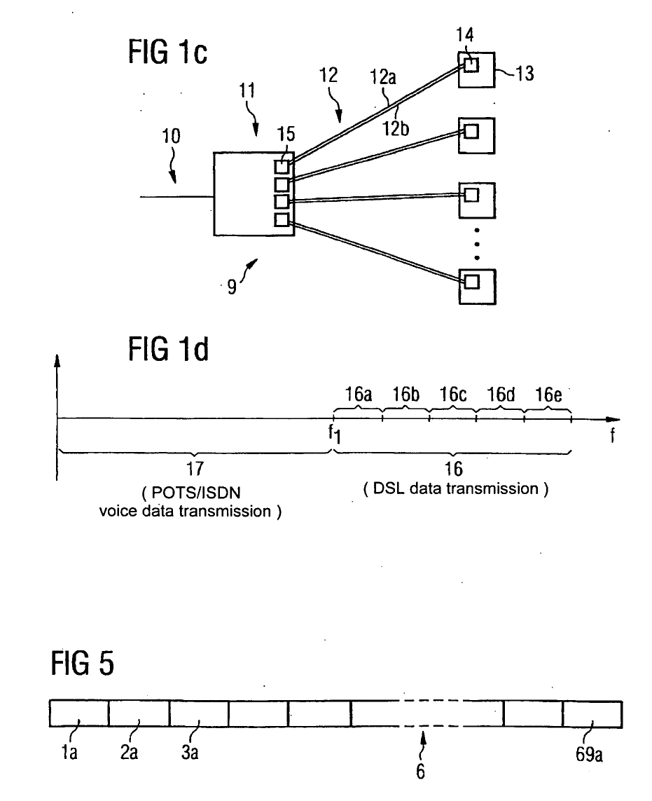

FIG. 1a a diagram of a phase star used to transmit useful and reference/synchronization data;

FIG. 1b a bit sequence allocation table used in the phase star shown in FIG. 1a;

FIG. 1c a diagram of a data communication system with transmitter/receiver devices according to this invention;

FIG. 1d a diagram of the frequency bands used by a transmitter/receiver device according to the invention for the POTS, ISDN and DSL data transmission;

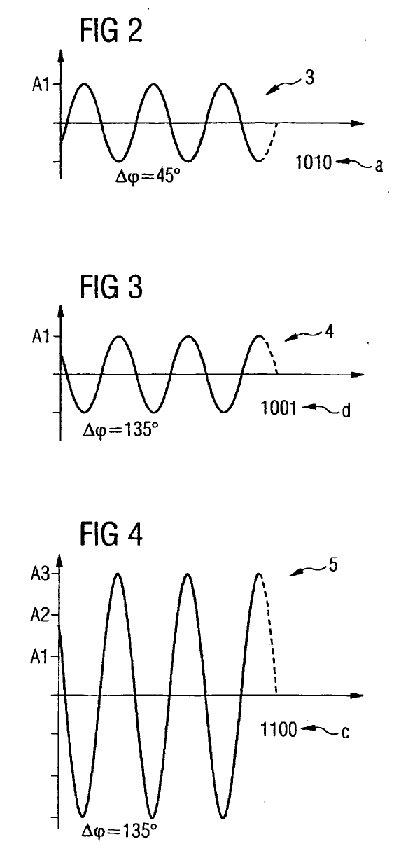

FIG. 2 a cosine oscillation used to transmit useful and reference/synchronization data;

FIG. 3 an additional cosine oscillation used to transmit useful and reference/synchronization data;

FIG. 4 a third cosine oscillation used to transmit useful and reference/synchronization data;

FIG. 5 a diagram of a super frame used to transmit useful and reference/synchronization data for the invention; and

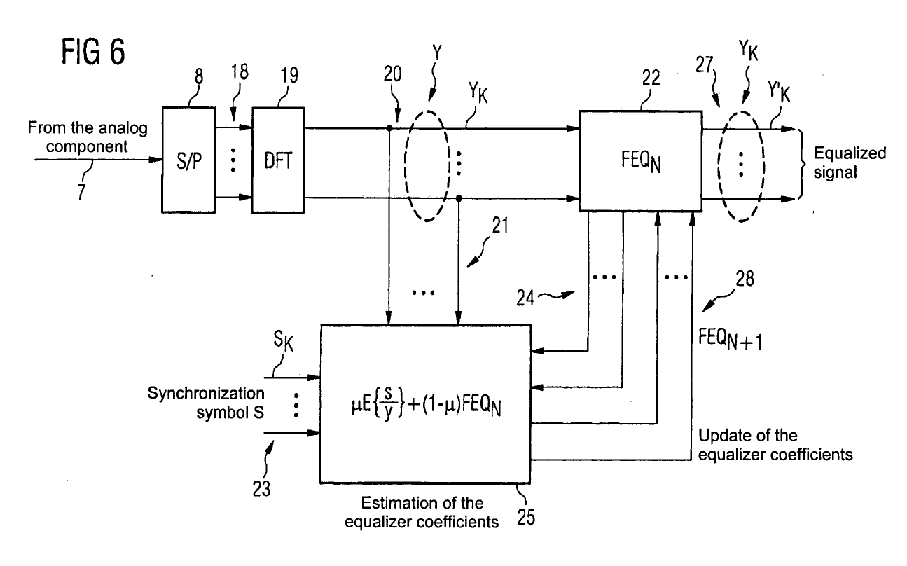

FIG. 6 a diagram of the structure and the functioning of the transmitter/receiver device shown in FIG. 1c.

FIG. 1c shows an example of a data communication system 9 according to this invention.

The data communication system 9 is a terminal exchange 11 (here: a digital electronic switching system or EWSD) connected to a telephone network (here: the public telephone network 10). In the terminal exchange 11 there are several transmitter/receiver devices 15 that in each case are connected via subscriber connecting lines 12, e.g. twisted-pair lines to transmitter/receiver devices 14 that are arranged in subscriber terminals 13. The twisted-pair lines in each case consist of two wires 12a, 12b. Differential or symmetrical signals are used to transmit data via the relevant wire pairs.

Data communication between the transmitter/receiver devices 15 provided in the terminal exchange 11 and the transmitter/receiver devices 14 of the subscriber terminals 13 takes place by means of POTS (plain old telephone service) or ISDN (integrated services digital network) voice data transmission as well as by means of xDSL (x digital subscriber line) data transmission.

According to FIG. 1d, a number of frequency bands (bins) 16a, 16b, 16c, 16d, 16e that are in a frequency range 16 (here: M different frequency bands) and lie above a frequency f1 are used in XDSL data transmission. The frequency range 17 below the frequency f1 is used for conventional POTS or ISDN voice data transmission. For a POTS data transmission, f1 amounts to approximately 25 kHz and for an ISDN data transmission to approximately 130 kHz.

For DSL data transmission between the corresponding terminal exchanges transmitter/receiver devices 15 and the subscriber transmitter/receiver devices 14 (and vice versa), a QAM method can for example be used. In this case, for each of the above-mentioned Ms, cosine carrier oscillations with different DSL frequency bands 16a, 16b, 16c, 16d, 16e whose frequencies can, for example, be in the middle of the corresponding frequency band 16a, 16b, 16c, 16d, 16e can be used.

In order to encode data (e.g. useful data as well as reference/synchronization data) in a cosine oscillation, the phase star 1 shown in FIG. 1a can for example be used.

As explained in greater detail below, the reference/synchronization data in the embodiment explained here serves to adjust an equalizer 22 and to synchronize the useful data transmission.

The phase star 1 in this embodiment has three concentric circles to which an oscillation amplitude A1, A2, A3 of specific heights is allocated in each case according to the representation below. A total of 16 points a, b, c, d, f (or expressed differently, 16 symbols a, b, c, d, f in the complex number level) are arranged on these circles to which one of 16 different sequences of 4 bits are allocated here in each case.

According to the allocation table 2 shown in FIG. 1b, the bit sequence “1010”, “0101”, “1001” or “0110” is allocated in each case to four points a, b, d, e (or four symbols a, b, d, e arranged in the complex number levels) that lie at the angles φ1, φ2, φ3 or φ4 of 45°, 135°, 225° or 315° on the inner-most circle allocated to the first amplitude A1.

According to the allocation table 2 shown in FIG. 1b, the bit sequence “1100”, “1111”, “0011” or “0011” is allocated accordingly in each case to four additional points c, f (or symbols c, f) that lie at corresponding angles φ1, φ2, φ3 or φ4 of 45°, 135°, 225° or 315° on the outer-most circle allocated to the third amplitude A3 according to FIG. 1a.

The remaining bit sequences (“1101”, “1110”, “1000”, “1011”, “0100”, “0111”, “0001”, “0010”) are allocated in each case to 8 points (or symbols) that lie at the angles φ5, φ6, φ7, φ8, φ9, φ10, φ11 or φ12 of approximately 20°, 70°, 110°, 160°, 200°, 250°, 290° or 340° on the middle circle allocated to the second amplitude A2.

In order to transmit useful data or reference/synchronization data from the terminal exchanges transmitter/receiver device 15 to the specific subscriber terminal transmitter/receiver device 14 and vice versa, a (in each case parallel to each of the above-mentioned frequency bands 16a, 16b, 16c, 16d, 16e) sequence of several, consecutively transmitted cosine oscillations 3, 4, 5 is transmitted continuously in each case for a specific duration (cf. FIGS. 2, 3, 4).

Depending on the frequency band used in each case, all the cosine oscillations 3, 4, 5 have a specific, constant frequency lying in the middle of the corresponding frequency band 16a, 16b, 16c, 16d, 16e as explained above.

Each cosine oscillation 3, 4, 5 identifies one of the above mentioned specific bit sequences and indeed via the height of the oscillation amplitude A1, A2, A3, and the phase displacement Δφ of the specific oscillation 3, 4, 5 compared to a basic clock rate running synchronously in the relevant transmitter/receiver devices 14, 15 or compared to a pilot-tone oscillation transmitted from the specific transmitter/receiver device 15.

In this case, the amplitudes A1, A2, A3 used in each case correspond to that amplitude to which the circle of the phase star 1 shown in FIG. 1a is allocated on which the point or the symbol a, b, c, d, e, f lies to which the bit sequence to be transmitted is allocated in each case.

The phase displacement Δφ of the specific cosine oscillation 3, 4, 5 is selected in such a way that it corresponds to the above-mentioned angle φ1, φ2, φ3, φ4, φ5, φ6, φ7, φ8, φ9, φ10, φ11 or φ12 of the point or symbol a, b, c, d, e, f allocated to the bit sequence in phase star 1 in each case.

For example, the cosine oscillation 3 shown in FIG. 2 identifies, by means of its amplitude A1 and its phase displacement of Δφ=45°, the bit sequence “1010” allocated to the point or the symbol a on the phase star 1; the cosine oscillation 4 shown in FIG. 3 identifies, by means of its amplitude A1 and its phase displacement of Δφ=135°, the bit sequence “1001” allocated to the point or the symbol d, and the cosine oscillation 5 shown in FIG. 4 identifies, by means of its amplitude A3 and its phase displacement of Δφ=135°, the bit sequence “1100” allocated to the point or the symbol c. Should as useful data or as the reference/synchronization data sequence, e.g. the data bit sequence “101010011100” be transmitted, this can result in the fact that e.g. the cosine oscillations 3, 4, 5 shown in FIGS. 2, 3 and 4 are transmitted consecutively from the terminal exchanges transmitter/receiver device 15 to the subscriber terminal transmitter/receiver device 14 (or vice versa).

According to the DSL protocol, the data is in each case transmitted in each frequency band 16a, 16b, 16c, 16d, 16d at predetermined time intervals, i.e. within specific frames. Therefore, as shown in FIG. 5, several (here: 69) different frames 1a, 2a, 3a, . . . , 69a each with a predetermined continuous duration are combined into one metaframe or super frame 6 (to which an additional metaframe is set up in the same way as the metaframe 6, etc.). The metaframes 6 can e.g. have a duration of 10-25 ms in each case, particularly of approximately 17 ms.

According to the DSL protocol, the first frame 1a of the metaframe 6 represents a so-called synchronization frame on which there are several (here: 68) data frames 2a, 3a, . . . , 69a.

According to the DSL protocol and the embodiment described here, the data frames 2a, 3a, . . . , 69a transmit useful data and (during an initializing phase—i.e. before the actual (useful) data transmission is started) reference data.

The reference data transmitted during the initializing phase is used to adjust the equalizer 22.

According to the DSL protocol, the synchronization frame or the first frame 1a is used to transmit the synchronization data. As described in greater detail below, this data is used together with the reference data in this embodiment—besides for synchronizing—particularly for adjusting, e.g. readjusting the equalizer 22.

In the case of an alternative embodiment not shown here it is for example feasible that within the data frames 2a, 3a, . . . , 69a only useful data, i.e.—also during the initializing phase—and no reference data is transmitted, i.e. the equalizer 22 is only adjusted on the basis of the reference/synchronization data transmitted within a synchronization frame.

FIG. 6 is a diagram of the setup and functioning of the transmitter/receiver device 14 shown in FIG. 1c.

The transmitter/receiver device 15 arranged in the terminal exchange 11 is set up accordingly and has corresponding functionalities in the same way as the subscriber terminal on the side of the transmitter/receiver device 14 as shown in FIG. 6.

In the subscriber terminal on the side of the transmitter/receiver device 14, the analog signals received from the terminal exchange 11 via the subscriber terminal 12 are converted in a (not shown) analog-digital converter into (serial) digital signals that are transmitted to a line 7.

The sequence of discrete signal values transmitted to the analog digital converter is then, as shown in FIG. 6, fed to a serial/parallel converter 8 via line 7 and converted into corresponding parallel, digital signals there.

The parallel, digital signals are fed to a Fourier transformation device 19 via a line bundle 18. Here, by means of a DFT method (DFT=discrete Fourier transformation), the amplitude Aₖ and the phase Δφₖ of the above-mentioned cosine carrier oscillations 3, 4, 5 allocated to different Ms are determined (or the M (complex) symbol values Yₖ allocated to the cosine carrier oscillations 3, 4, 5 with an amplitude Aₖ and a phase Δφₖ (vector Y) in each case).

The amplitudes Aₖ and phases Δφₖ (or the M (complex) symbol values Yₖ) are fed to an equalizer 22 via line bundle 20 consisting of several additional lines and the equalized signals (shown here with M (complex) symbol values Y′ₖ, vector Y′) for additional signal processing and then via a line bundle 27 consisting of several additional lines to an evaluation unit (not shown).

DSL data transmission via the twisted-pair line 12 can for many reasons bring about that the originally transmitted signals are distorted.

The (adjustable) equalizer 22 compensates for the distortions.

The equalizer 22 can have e.g. a number of digital filter devices with a (or more, e.g. cascaded) digital filters in each case. The filter coefficients of the digital filters can be adjusted from the outside e.g. by applying corresponding control signals to the corresponding control lines of a line bundle 28.

The above-mentioned equalizer 22 particularly the filter coefficients of the included digital filters are adjusted in such a way that the received signals are equalized (as good as possible) particularly in such a way that the formula below applies to each of the above-mentioned (complex) symbol values Y′ₖ transmitted by the equalizer 22—considered in the frequency range:
Y′ₖ=FEQₖYₖ (formula (1))
or the formula
Y′ₖ=H⁻¹ₖYₖ (formula (2))

In this case, FEQₖ or H⁻¹ₖ is the inverse of the estimated (channel) transmission function Hₖ applicable to the kth channel or the kth frequency band 16a, 16b, 16c, 16d, 16e (of the total of M channels or M frequency bands).

The equalizer 22 or the filter coefficients are adjusted during the initializing phase in, for example, a well-known way on the basis of the reference data transmitted during the data frames 2a, 3a, . . . , 69a.

Because the distortion characteristics of the specific transmission channel change continuously, the equalizer 22 is readjusted at regular intervals after the initializing phase.

The equalizer 22 or the filter coefficients are adjusted or readjusted as explained in greater detail below on the basis of the reference/synchronization data transmitted during the synchronization frame 1a.

Alternatively or additionally, the reference/synchronization data transmitted during the synchronization frame 1a to adjust the equalizer 22 or the filter coefficients can also already be used during the initializing phase. I

As has already been mentioned, the (equalized) signals (i.e. the above-mentioned M (complex) symbol values Y′ₖ, vector Y′) are fed from the equalizer 22 to the evaluation unit (not shown) via line bundle 27. Here, by means of a phase star corresponding to the phase star 1 shown in FIG. 1a, from the (equalized) signals Y′ₖ provided by the equalizer 22, in greater detail: the included (equalized) amplitude values A′ₖ and (equalized) phase values Δφ′ₖ that determine these allocated bits or bit sequences transmitted in each case by the cosine carrier oscillations 3, 4, 5 received from M.

The determined bit sequences are compared to the reference/synchronization data bit sequences stored in a storage device (not shown) of the transmitter/receiver device 14.

Depending on whether or not an agreement can be reached, the bit sequences reached in each case can be allocated to a synchronization frame 1a or a data frame 1a, 2a, 3a (cf. FIG. 5). As a result of the fact that during the synchronization frame 1a the above-mentioned reference/synchronization data bit sequences are transmitted, it is possible that a temporary coordination of the DSL data transmission between the transmitting and the receiving transmitter/receiver device 14, 15 can be reached in each case.

As is shown in FIG. 6, the M (complex) symbol values Yₖ allocated to the M cosine carrier oscillations 3, 4, 5 via a line bundle 21 consisting of several lines are fed to an equalizer coefficient estimation means 25.

If the above-mentioned evaluation device determines that a reference/synchronization data bit sequence was received, the inverse H⁻¹ₖ of the specific (channel) transmission function Hk is estimated by the equalizer coefficient estimation means 25 for each of the above-mentioned M cosine carrier oscillations 3, 4, 5 or for each of the above-mentioned M frequency bands 16a, 16b, 16c, 16d, 16e.

As has already been explained, the reference/synchronization data bit sequences transmitted in the transmitter/receiver device 14 during a synchronization frame 1a is well-known and as a result also the (complex) symbol values Sₖ allocated to the phase star corresponding to the phase star shown in FIG. 1.

The (complex) symbol values Sₖ are read out from the above-mentioned storage device (not shown here) of the transmitter/receiver device 14 and, according to FIG. 6, fed to an equalizer coefficient estimation means 25 via a line bundle 23 consisting of several lines.

In order to estimate the inverse H¹ₖ of the (channel) transmission function Hₖ applicable to the kth channel, the expected value of the quotients Sₖ/Yₖ is determined in the equalizer coefficient estimation means 25—separately for each of the M channels or M frequency bands 16a, 16b, 16c, 16d, 16e—e.g. by the average value formation. (For example, by using 10, 100 or 1000 consecutively corresponding symbol values Yₖ or Sₖ. These can, for example, be allocated to one and the same synchronization frame 1a or e.g. also to several, consecutive synchronization frames.)

Therefore, expressed according to the formula, in the equalizer coefficient estimation means 25 to determine the inverse H¹ₖ of the transmission function Hₖ of the kth of the total of M carriers, the following operation is carried out:
H⁻¹ₖ=E{Sₖ/Yₖ} (Formula (3))
in which case a mathematical expected value operator is designated with E { . . . }.

In the DSL data transmission via the above-mentioned twisted-pair line 12 there may be many reasons for interferences. In particular, there may be cross-talk interferences that are called up from neighboring twisted-pair lines—particularly if a DSL data transmission has just been carried out via one (or several) neighboring twisted-pair line(s).

The corresponding interferences, amongst others, do not correlate with the useful signal so that the mean value of all the relevant interfering signals at the above-mentioned expected value or average value formation (when considering a sufficiently high number of symbols Yₖ or Sₖ) is ascertained more or less.

As is shown in FIG. 6, the adjustments or filter coefficients particularly the above-mentioned FEQₖ values (vector FEQ) (see formula (1)) used last in the equalizer 22 are allocated to the equalizer coefficient estimation means 25.

The FEQₖ values (i.e. the M values of the vector FEQ) are designated with “FEQ_{k, N}” below (and together form the vector FEQ_{N}) and the updated FEQₖ values with “FEQ_{k, N+1}” (these together form the vector FEQ_{N+1}).

The (different Ms in each case allocated to a total of M carriers) FEQ_{k, N} values are weighted with a weighting coefficient μ′ and those determined according to the above-mentioned formula (3) determined (different Ms in each case allocated to one of the corresponding M carriers) expected values E {Sₖ/Yₖ} with an additional weighting coefficient μ in each case.

In this case, μ+μ′=1, i.e. μ′=1−μ applies. μ>0,5 is advantageous. For example, 0,5<μ<0,9 applies particularly if 0,6<μ<0,8.

The resulting, correspondingly weighted values of E {Yₖ/Sₖ} or FEQ_{k, N} are added together so that the following formula applies to the kth of the total of M different, updated FEQ_{k, N+1} values:
FEQ_{k, N+1}=μE{Sₖ/Yₖ}+(1−μ)FEQ_{k,N} (Formula (4))

The correspondingly updated values FEQ_{k, N+1} are then fed via the line bundle 28 from the equalizer coefficient estimation means 25 to the equalizer 22 and these are then readjusted according to the above-mentioned representation (i.e. the filter coefficients of the digital filters are adjusted accordingly (new)).

The above-explained functions of the equalizer coefficient estimation means 25, the Fourier transformation device 19, the equalizer 22, etc. can e.g. be fulfilled in a suitable way by several intercommunicating microprocessors or e.g. also by one and the same microprocessor.

In the case of the above-described method—particularly if the initializing phase of the transmitter/receiver device has ended (i.e. during the actual transmission of useful data)—the equalizer 22 can be adjusted relatively quickly and with a relatively high accuracy. The good signal equalizing leads to a lower bit error rate pared to the prior art.

1-15 (cancelled)

16. A receiver device adapted to receive modulated transmission signals from a transmitter, comprising:
a transmission channel to transmit the modulated transmission signals;
synchronization data transmitted by the transmission signals to synchronize the receiver device; and
an equalizer operatively associated with the receiver device to equalize the received or derived signals, wherein the transmission signals that transmit the synchronization data are used in the receiver device to adjust the equalizer.

17. The device according to claim 16, wherein the receiver device is a transmitter/receiver device.

18. The device according to claim 17, wherein the synchronization data includes a synchronization data bit sequence which is compared with a synchronization of the receiver or transmitter/receiver device with a bit sequence initially stored in a storage device of the receiver or transmitter/receiver device.

19. The device according to claim 17, wherein a transmission signal with a specific amplitude (A1) and a phase (φ1) is allocated to each bit or bit sequence to be transmitted.

20. The device according to claim 17, wherein the equalizer which equalizes the received or derived signals transmitted in a frequency range is subjected to a Fourier transformation operation.

21. The device according to claim 20, wherein the Fourier transformation operation is a discrete Fourier transformation or DFT operation.

22. The device according to claim 20, wherein to adjust the equalizer a symbol value (Yₖ) obtained according to the frequency range transformation of the signals and a well-known or determined symbol value (Sₖ) allocated to the synchronization data in the receiver or transmitter/receiver device are used.

23. The device according to claim 22, wherein to adjust the equalizer a quotient is in each case formed from the symbol value (Sₖ) allocated to the synchronization data and the corresponding symbol value (Yₖ) obtained according to the frequency range transformation of the signals.

24. The device according to claim 23, wherein to adjust the equalizer the expected value of the several quotients is formed in each case according to the synchronization data symbol values (Sₖ) and the signal transformation symbol values (Yₖ).

25. The device according to claim 24, wherein to update the adjustment of the equalizer, one or several characteristics (FEQ_{k, N}) are also used that identify the adjusting of the equalizer before it is updated.

26. The device according to claim 24, wherein the transmission signals are QAM-modulated signals.

27. The device according to claim 24, wherein the transmission signals are DSL-modulated signals.

28. The device according to claim 24, wherein the transmission signals that are used to synchronize the receiver or transmitter/receiver device and to adjust the equalizer are transmitted during a synchronization frame.

29. A data communication system having a receiver device adapted to receive modulated transmission signals from a transmitter, comprising:
a transmission channel to transmit the modulated transmission signals;
synchronization data transmitted by the transmission signals to synchronize the receiver device; and
an equalizer operatively associated with the receiver device to equalize the received or derived signals, wherein the transmission signals that transmit the synchronization data are used in the receiver device to adjust the equalizer.

30. The data communication system according to claim 29, wherein the receiver device is a transmitter/receiver device.

31. A data reception method used in a data communication system, comprising:
transmitting a modulated transmission signal via a transmission channel;
receiving the modulated transmission signal by a receiver or transmitter/receiver device;
transmitting synchronization data to synchronize the receiver or transmitter/receiver device via the transmission signals; and
equalizing the received or derived signals by an equalizer, wherein the transmission signals are used in the receiver device to adjust the equalizer.
